(19) United States
(12) Patent Application Publication
(10) Pub. No.: US 2004/0151338 A1
(43) Pub. Date: Aug. 5, 2004

(54) Thin type full-range speaker

(76) Inventor: Steff Lin, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/358,329

(22) Filed: Feb. 5, 2003

(51) Int. Cl. H04R 1/00; H04R 9/06; H04R 11/02

(52) U.S. Cl. 381/401; 381/398

(57) ABSTRACT

A thin type full-range speaker includes a magnetic structure, the voice coil of the magnetic structure having two reversed winding sections arranged at different elevations, a cone rack fastened to the magnetic structure around the voice coil, a cone suspended above the voice coil, the cone having a recessed center hole, a double-layer type corrugated suspension radially extended around the periphery thereof and suspended from the cone rack and embedded with a packing strip, a buzzer element mounted in the recessed center hole of the cone, and a diaphragm suspended in the recessed center hole above the buzzer element.

### BACKGROUND OF THE INVENTION

1. Field of the Invention

The present invention relates to a full-range speaker and, more particularly, to a thin type full-range speaker, which limits the vibration of the voice coil to a proper amplitude range, preventing a distortion of sound.

2. Description of the Related Art

Conventional speakers are commonly designed for a particular range. There are also known speakers for full-range output. However, these full-range speakers commonly have a certain thickness.

FIGS. 1A˜1C show the operation of the voice coil in a speaker according to the prior art. According to this design, the voice coil 2 is moved relative to a washer 23 at a magnet 24 in an iron plate 25. Winding an enameled wire 21 round a bobbin 22 in clockwise direction forms the voice coil 2. When positive signal inputted, the magnetic line of force of the enameled wire 21 extends in clockwise direction, and the magnetic line of force of the magnetic loop moves in direction from N (iron plate 25) toward S (Washer 23), resulting in a high density of magnetic flux in the bottom side of the enameled wire 21 and a low density of magnetic flux in the top side of the enameled wire 21. Therefore, the voice coil 2 is forced to displace upward (see FIG. 1B). On the contrary, when a negative signal inputted, the voice coil 2 is forced to displace downward (see FIG. 1C). Due to this drawback, the thickness of the speaker cannot be greatly reduced.

### SUMMARY OF THE INVENTION

The present invention has been accomplished under the circumstances in view. It is therefore the main object of the present invention to provide a thin type speaker, which achieves a full-range voice output. It is another object of the present invention to provide a thin type full-range speaker, which limits the vibration of the voice coil to a proper amplitude range, preventing a distortion of sound. According to one aspect of the present invention, the thin type full-range speaker comprises a U-shaped iron plate, a magnet mounted within the iron plate, a voice coil disposed above the magnet, a cone rack fastened to the iron plate around the voice coil, a woofer cone suspended above the voice coil, the woofer cone having a recessed center hole, a corrugated suspension radially extended around the periphery thereof and suspended from the cone rack and embedded with a packing strip, a buzzer element mounted in the recessed center hole of the cone, and a diaphragm suspended in the recessed center hole above the buzzer element. According to another aspect of the present invention, the voice coil has two reversed winding sections arranged at different elevations. The reversed winding sections of the voice coil limit the vibration of the winding coil to a suitable amplitude range, preventing a distortion of sound.

### BRIEF DESCRIPTION OF THE DRAWINGS

FIGS. 1A˜1C are schematic drawings showing the operation of the voice coil according to the prior art.

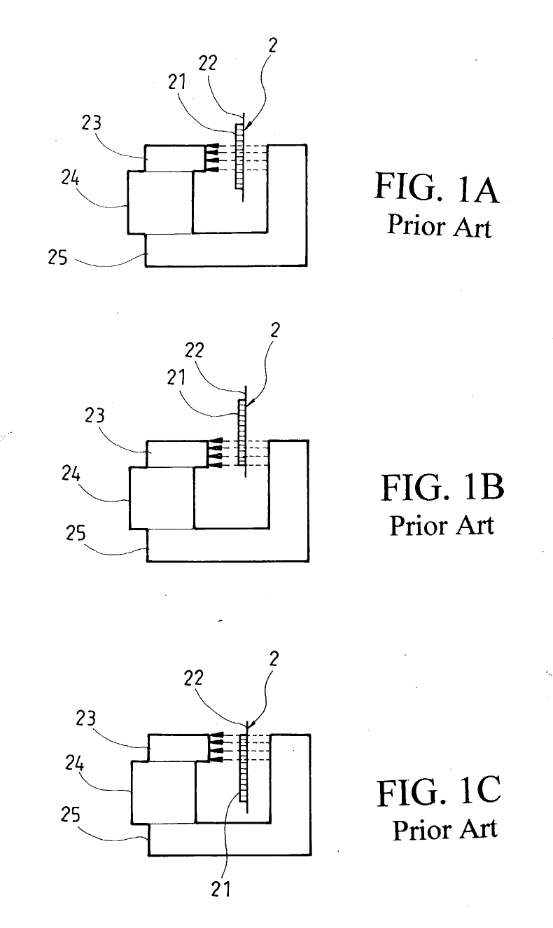

FIG. 2 is an elevational view of a thin type full-range speaker according to the present invention.

FIG. 3 is an exploded view of the thin type full-range speaker according to the present invention.

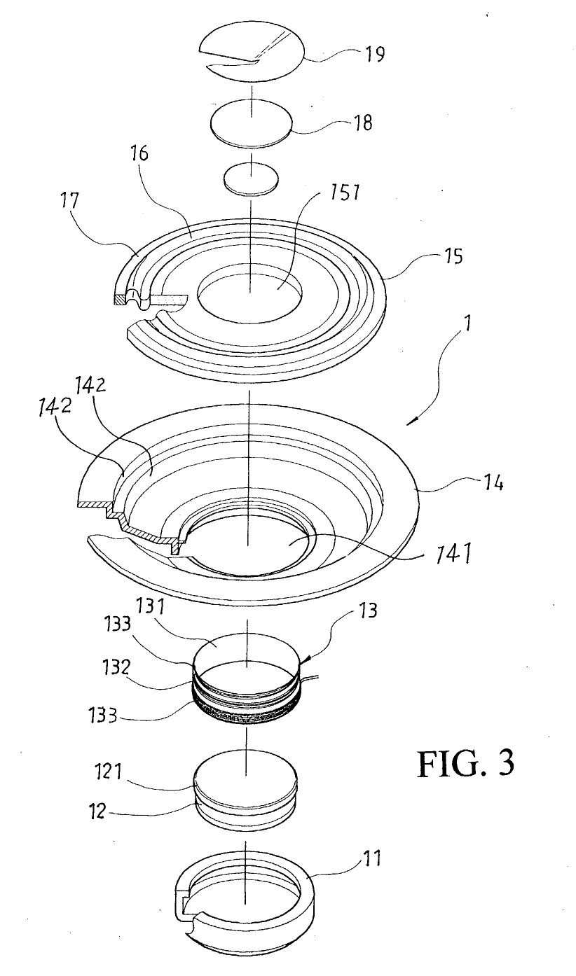

FIG. 4 is a sectional view in an enlarged scale of the thin type full-range speaker according to the present invention.

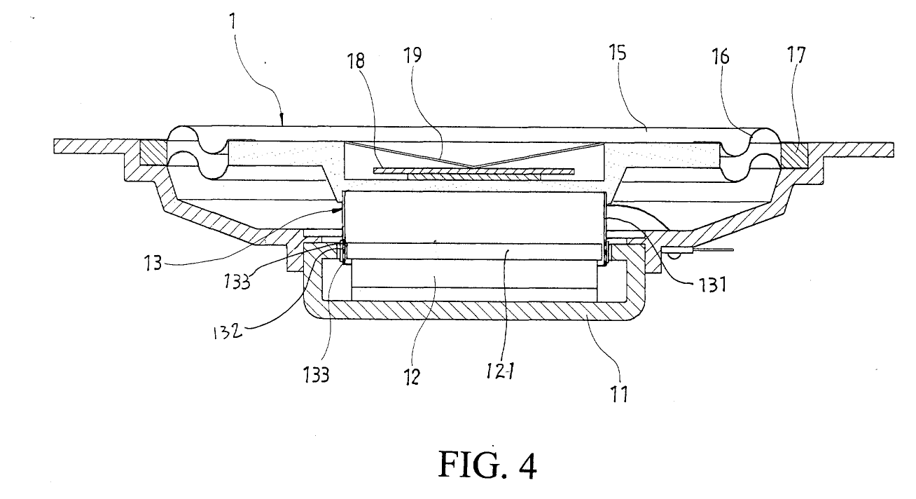

FIGS. 5A˜5C are schematic drawings showing the operation of the voice coil according to the present invention.

### DETAILED DESCRIPTION OF THE PREFERRED EMBODIMENT

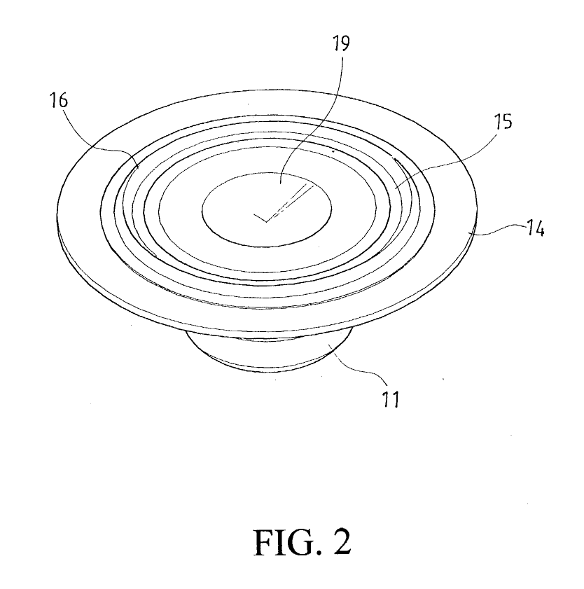

Referring to FIGS. 2˜4, a thin type full-range speaker 1 in accordance with the present invention is shown comprising a substantially U-shaped iron plate 11, a magnet 12 mounted within the U-shaped iron plate 11, a voice coil 13 provided at the top of the magnet 12, a cone rack 14 mounted on the U-shaped iron plate 11 and around the voice coil 13, a woofer cone 15 suspended within the cone rack 14, a buzzer element 18, and a diaphragm 19. The U-shaped iron plate 11, the magnet 12 and the voice coil 13 form a magnetic structure.

The cone rack 14 has a center coupling hole 141 fastened to the iron plate 11, and an inside annular step 142 neat the periphery. The voice coil 13 is formed of at least one enabled wire 131, having a first winding section 132 and at least one, for example, two winding sections 133 arranged at different elevations and extended in reversed directions. Therefore, when the voice coil 13 moved, it does not escape out of the range of the washer 121 of the magnet 12. The woofer cone 15 is made from foamed polyurethane, having a recessed center hole 151, a corrugated suspension 16, and a packing strip 17 embedded in the corrugated suspension 16. The corrugated suspension 16 is fixedly fastened to the inside annular step 142 of the cone rack 14. The buzzer element 18 is mounted within the recessed center hole 151 of the cone 15. The diaphragm 19 is fastened to the periphery of the recessed center hole 151 of the cone 15 in flush with the top surface of the cone 15.

When electrically connected, electric current passing through the voice coil 13 to drive the magnet 12, causing the buzzer element 18, the cone 15 and the corrugated suspension 16 to produce high-range, midrange and low-range sounds, achieving the desired full-range voice output.

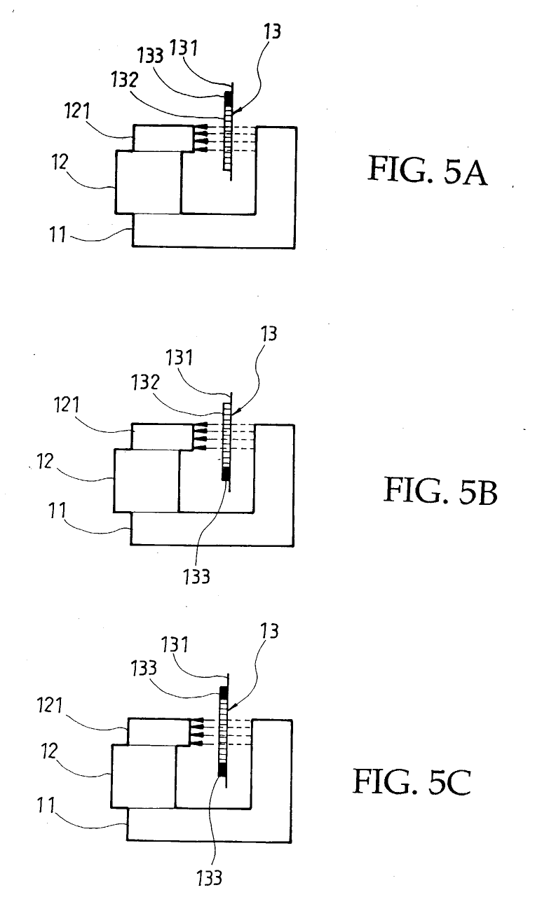

With reference to FIGS. 5A˜5C, as indicated above, the voice coil 13 has a first winding section 132 and two second winding sections 133 arranged at different elevations and extended in reversed directions. The first winding section 132 and the second winding section 133 vibrate in reversed directions, limiting the vibration of the voice coil 13 to a suitable amplitude range to prevent the occurrence of distortion of sound. According to this embodiment, the first winding section 132 is connected between the second winding sections 133.

What the invention claimed is:

1. A thin type full-range speaker comprising a magnetic structure, a cone rack fastened to said magnetic structure around a voice coil of said magnetic structure, and a woofer cone suspended within said cone rack above said voice coil, wherein said woofer cone has a corrugated suspension formed of two suspension layers and radially extended around the periphery thereof and suspended from said cone rack, a packing strip embedded in said corrugated suspension, a recessed center hole, a buzzer element mounted inside said recessed center hole, and a diaphragm suspended in said recessed center hole above said buzzer element; said voice coil comprises a first winding section and at least one second winding section arranged at different elevations and extended in reversed directions.

2. The thin type full-range speaker as claimed in claim 1, wherein said cone is made from foamed polyurethane or other material.

3. The thin type full-range speaker as claimed in claim 1, wherein said first winding section and at least one second winding section of said voice coil are formed of one single enameled wire.

4. The thin type full-range speaker as claimed in claim 1, wherein said first winding section and at least one second winding section of said voice coil are formed of a respective enameled wire and electrically connected together.
